(19) United States
(12) Patent Application Publication
(10) Pub. No.: US 2025/0228246 A1
(43) Pub. Date: Jul. 17, 2025

(54) MIXTURE FOR ANTIFUNGAL, ANTIBACTERIAL AND ANTIVIRAL TREATMENT

(71) Applicants: Gianni Arturo CONTE, Zevio (VR) (IT); Francesco MARIN, Spilimbergo (PN) (IT); Sergio SALVADOR, Vittorio Veneto (TV) (IT); Simone VINCENZI, San Vendemiano (TV) (IT)

(72) Inventors: Gianni Arturo CONTE, Zevio (VR) (IT); Francesco MARIN, Spilimbergo (PN) (IT); Sergio SALVADOR, Vittorio Veneto (TV) (IT); Simone VINCENZI, San Vendemiano (TV) (IT)

(21) Appl. No.: 18/850,063

(22) PCT Filed: Mar. 24, 2023
(86) PCT No.: PCT/IB2023/052945

§ 371 Date: Sep. 24, 2024

(30) Foreign Application Priority Data
Mar. 25, 2022 (IT) 102022000005990

(51) Int. Cl. A01N 59/20; A01N 25/08; A01N 33/04; A01N 43/16; A01N 65/03

(52) U.S. Cl. CPC A01N 59/20; A01N 25/08; A01N 33/04; A01N 43/16; A01N 65/03

(57) ABSTRACT

Mixture for the antifungal, antibacterial and antiviral treatment of plants and of ingredients or foods intended for human and/or zootechnical consumption includes:
at least one chitosan or at least on salified chitosan from 35% to 85 % by weight,
at least one cationic surfactant from 0.05% to 40% by weight,
at least one compound containing copper from 0.1% to 10% in the case of mixtures intended for treatment for human or animal nutrition and from 10% to 40% in the case of mixtures intended for the control of fungal diseases in plants
at least one inorganic acid from 2% to 20% by weight, and/or at least one organic acid from 10% to 20%, with an overall pH between 2.0 and 8.4.

### CROSS REFERENCE TO RELATED APPLICATIONS

This application is a 371 National Phase of PCT/IB2023/052945, filed Mar. 24, 2023, which claims priority of Italian Application No. 102022000005990, filed Mar. 25, 2022, the entire contents of all of which are incorporated by reference herein as if fully set forth.

### FIELD OF THE INVENTION

The present invention relates to a mixture for the antifungal, antibacterial and antiviral treatment of plants and parts thereof, such as buds, leaves and fruits, whether they are intended for human nutrition or animal feed. or any industrial processing or transformation. Furthermore, the mixture is intended for the treatment of medicinal and/or ornamental plants as well as for the treatment of the fruits of plants immediately before harvesting or at any time after this. It finds advantageous use in products intended for human and/or zootechnical nutrition as an inhibitor of the development of moulds, fungi and bacteria.

### BACKGROUND

It is known that during the various vegetative stages plants are subject to attack by fungal and bacterial pathogens which can affect all their parts, in particular the edible ones, both before and after harvesting. Furthermore, even environmental factors, such as air that is too dry and/or hot and/or conditions of increased or decreased humidity, which occur in the open field rather than in a controlled environment, can have a negative effect not only on plant growth but also, after harvesting, on the conservation of their edible parts.

In fact, even after harvesting, the plants, or their parts and/or their fruits, may be affected by the aggression of pathogenic agents or by phenomena of high dehydration as often occurs, for example, for grapes which, placed in particular rooms called “appassitoi” or “fruttai”, undergo alterations of a biological nature, caused by fungi and bacteria, and/or physical, caused by excessively accelerated drying conditions.

It is known in particular that in the agricultural sector certain types of fungi and mycotoxins and certain types of bacteria can infect cultivated plants and cause considerable damage to them and their fruits, both in terms of quantity and quality of the harvest, and require adequate interventions to safeguard their integrity. In particular, in viticulture the vines and/or bunches of grapes are potentially attacked by pathogenic fungi such as Plasmopora viticola, Botrytis cinerea and Uncinola necator (which cause diseases such as downy mildew, botrytis or gray rot or gray mould, and powdery mildew or white powdery mildew) and bacteria such as Agrobacterium vitis and Xanthomonas spp and A. cetobacter spp.

In agricultural crops it is also known to use substances which limit the development and prevent, or at least reduce, the spread of fungi and pathogenic bacteria, which can cause, very often just before the harvesting phases, damage to the edible parts consequently causing economic losses often of considerable size.

Currently, fungal and bacterial parasites are mainly contrasted with chemical synthesis preparations, which are administered to plants in precise phenological phases or according to precise treatment schedules. They have proved to be effective, but they also highlight problems and important limitations and drawbacks.

An important problem is related to the fact that international legislation, European in this case (https://food.ec.europa.eu/system/files/2022-06/pesticides_sud_eval_2022_reg_2022-305_en.pdf) promotes a 50% reduction within by 2030 of chemical synthesis pesticides used to reduce the chemical risk associated with the use of these substances as well as to promote low-risk substances for the control of harmful pests of agricultural crops.

An inconvenience, linked to the climate change that has been occurring for some time, consists in the strong losses of water through the transpiring parts of the plants, such as the leaves and the fruits, and their consequent dehydration both in the plant and in the edible parts after harvesting.

To reduce this drawback it has already been proposed to treat plants and parts of plants with a mixture comprising in solution chitosans and acids in solution and intended to be sprinkled on the plants before harvesting their edible parts or even after their harvest. In the case of vines, this mixture can be sprayed both on the bunches of grapes detached from the plants and on the transformation products, for example the must. It proved to be valid but also revealed its limitations consisting of:
an unsatisfactory gripping power of the polysaccharide molecule to plants and/or their edible parts,
an antimicrobial action that can be improved,
a poor suitability for its mixing with products containing copper and sulfur, useful for obtaining important synergies in the fight against pathogens, especially fungi, which afflict plants,
the unsuitability for its administration by the endotherapeutic route
the unsuitability for its use in the liquid formulation for the treatment of seeds.

CN 107869486 describes a mixture comprising a particular cationic surfactant, Ethyl-N-lauroyl-L-arginate HCL, or LAE and Methilparaben, to be used as “save freshness” through treatments on fruit and plants. However, the use of that mixture as a promoter of the well-being of all parts of the plant is excluded, i.e. the use to protect the health of all parts of the plant treated during all the phenological periods that characterize it is not considered, allowing the maintenance of health of the plant and its production.

CN 106720267 describes a mixture containing LAE and antibiotic molecules such as Natamycin and Nisin and has the purpose of preserving fruit and plants through a composite coating of chitosan and antibiotics. The document does not provide for the use of the mixture in the agronomic field in order to promote the defense of plants and their fruits from microbiological parasitic attacks. Furthermore, the use of said mixture is not envisaged in the recipes for the preparation of foods and beverages for human and zootechnical use as an additive or adjuvant.

US 2019/0045789 provides for the use of a mixture of LAE added to hydrogen peroxide and a possible third molecule to promote the sanitization of surfaces, including those of food products and human skin in order to prevent infections (food safety and prevention of nosocomial infections). Not even this document deals with the issue of systematic defense of plants grown in open fields and their protection from microbiological attacks during all their vegetative stages in order to guarantee the harvesting of the same or of their fruits in conditions of maintained health. Furthermore, this document does not consider the use of copper as a molecule synergizing the defense against microorganisms, nor the use of the proposed mixture as an additive or adjuvant in food recipes intended for humans or animals.

The publication Ma Qiumin et Al. “Quality attributes and microbial survival on whole cantaloupes with antimicrobial coatings containing chitosan, lauric arginate, cinnamon oil and ethylenediaminetetraacetic acid”in INTERNATIONAL JOURNAL OF FOOD MICROBIOLOGY presents the results of a research which aims to demonstrate that a mixture of LAE and chitosan lowers the level of general microbiological load in order to safeguard hygiene of the product considered and the health of the consumer with respect to particular harmful microorganisms. The research does not express the possibility of using the mixture in the systematic protection of plants during all the phenological phases of production. Furthermore, the research does not foresee the use of copper in the proposed mixture.

The purpose of the invention is to overcome the limits of the state of the art and to propose a disinfestant mixture for plants in general against pathogenic agents such as viruses, chromists or pseudofungi, phytoplasmas, fungi, bacteria, which is more efficient than known disinfesting products and which, unlike these, have a shorter or more acceptable “waiting period”.

Another object of the invention is to propose a disinfestant mixture which inhibits or at least reduces the proliferation and spread of fungi, bacteria, pseudo-fungi and pathogenic viruses, which can attack plants or parts thereof, particularly in the presence of atmospheric phenomena such as hail event.

Another object of the invention is to propose a disinfestant mixture which makes plants resistant to the results of parasitic attacks by insects, which can cause wounds both to the plants themselves and, more specifically, to their fruits.

Another object of the invention is to propose an environmentally friendly mixture for the protection of diseases affecting plants.

Another object of the invention is to propose an environmentally friendly mixture for the antifungal and antibacterial treatment of grapes, fruit, plants, plants in general and parts of these, even after harvesting, and which can also be well tolerated by consumers both in the case the vegetable or parts of it is consumed fresh, and in the case the consumption concerns the products deriving from the transformation of the vegetable.

Another purpose of the invention is to propose a mixture capable of improving the health conditions of plants in order to preserve the quality and quantity of agricultural production.

Another object of the invention is to propose a mixture with which the aerial parts and/or roots of plants can be sprinkled even after they have been harvested, and this both in liquid and powder form.

Another object of the invention is to propose a disinfestant mixture which can be administered endotherapically if the pathologies to be counteracted concern the vascular parts or the internal wood of the plants.

Another object of the invention is to propose a mixture which improves the preservability of agricultural products after harvesting and in particular of fruits, plant parts, buds, leaves, flowers and seeds.

Another object of the invention is to propose a mixture which guarantees the conditions of health in plants or parts thereof affected by adverse weather conditions or by wounds inflicted by insects or animals.

Another object of the invention is to propose a mixture which improves the resistance of plants to water stress which is expressed by inducing the closure of their stomata.

Another object of the invention is to propose a mixture capable of making house plants, aromatic plants and cut flower plants free from contamination by synthetic chemical substances and therefore usable in domestic environments, which are generally closed or not very aired.

Another object of the invention is to exploit the edibility characteristics of the formulation, where the raw materials used possess the appropriate chemical and legal requirements, to contain contamination and the development of fungi, molds and bacteria in foods intended for human consumption and animal husbandry. In particular, the mixture can be usefully mixed with flours, doughs, creams, soft cheeses, etc. Furthermore, the mixture can also be used for microbiological contrast as a surface protector of foods such as seeds, cheeses, fruit, meats, eggs, etc. A particular application is the contrast of lactic acid and acetic acid bacteria, as well as the Brettanomyces fungus bruxellensis (spp)/Dekkera (spp) in the production and conservation of sugary musts in wines and fermented and non-fermented beverages, in general. In this last case the molecules used in the blend find application and effectiveness even if used separately but express particular synergy when used together.

Another object of the invention is to exploit in a synergistic and contemporary way, in the case of vegetable treatments, the eliciting activity of the chitosan molecule added to the bactericidal/fungicidal capacity of the cationic surfactant and copper.

### SUMMARY

All these objects and others which will result from the following description are jointly or severally achieved according to the invention with a mixture for the antifungal and antibacterial treatment of plants in general and of ingredients or foods intended for human and/or zootechnical consumption, as defined in the appended claims.

In its general formulation, it includes the following fundamental components:
at least one chitosan as such or salified from 35% to 85% by weight, preferably from 40% to 70%,
at least one cationic surfactant from 0.05% to 40% by weight, preferably from 4% to 30%,
at least one compound containing copper, from 0.01% to 50% by weight, preferably from 0.1% to 10% in the case of mixtures intended for treatment for human or animal nutrition and from 10% to 40% in the case of mixtures intended for the control of fungal diseases in plants
at least one inorganic acid from 2% to 20% by weight, preferably from 5% to 15% and/or at least one organic acid from 10% to 20%, preferably from 3% to 15% with an overall pH between 2.0 and 8.4, preferably between 4.0 and 7.0.

Among these components there is also copper, as a molecule linked to inorganic or organic compounds depending on whether the mixture submitted to the patent application is used in the agronomic field rather than food or livestock. It is in fact known that copper is a powerful antimicrobial which, if used in conjunction with the other ingredients included in the formulation, chitosan and cationic surfactant, synergizes and enhances the initially proposed mixture.

It is likewise known that until now the liquid mixtures with chitosan component were not miscible with copper as this caused the mixture itself to gel quickly and massively, making it practically impossible to use it by spraying on the targets on which the application was envisaged. According to the present invention the simultaneous presence of a cationic surfactant helps to maintain the liquid characteristic of the mixture, effectively making the molecule containing the copper usable together with the chitosan. Of course this is true if the mixture to be prepared is liquid; if, on the other hand, the mixture maintains its solid (powdery) characteristics up to the moment of treatment of the targets, the problem of the miscibility of the various components does not arise since they are perfectly miscible in the powdery state. In this case, however, the copper-added mixture will be enhanced with respect to the microbiological containment activities.

### DETAILED DESCRIPTION OF THE PREFERRED EMBODIMENTS

The present invention is hereinafter further explained in some of its preferred practical embodiments, reported for purely exemplifying and non-limiting purposes.

In the present description, the term “field” refers to plants grown in the open ground or in more controlled conditions, typically greenhouses, or in environments which can be isolated from the external environment and which, if necessary, allow the control of the light, temperature and more. Furthermore, the term “fruit” refers to everything that is commonly considered fruit, even if it is not from a botanical point of view. Therefore, with “fruit” here we also mean the so-called “false fruit”, which can be, for example, an aggregate fruit, such as a strawberry, a composite fruit such as an apple and a pear, a coalescence of fruits, such as pineapples, etc.

The mixture according to the invention comprises the following basic components, each present in the range of weight percentage values indicated next to each component:
a chitosan optionally salified with hydrated inorganic acids or a mixture of chitosans, optionally salified with hydrated inorganic acids: from 35% to 85%, preferably from 40% to 70%,
a cationic surfactant or a mixture of cationic surfactants: 2% to 40%, preferably 4% to 30%,
at least one compound containing copper: from 0.1% to 50%, preferably from 0.1% to 10% in the case of mixtures intended for human or animal nutrition and from 10% to 40% in the case of mixtures intended for fungal disease control in plants. The molecules containing copper which can be advantageously used are, preferably, copper sulphate, copper oxychloride and copper hydroxide; moreover, specifically for the production of products intended for human or zootechnical alimentation, organic molecules containing copper can be used, such as in particular copper gluconate, copper citrate or copper lactate or complexes of chlorophylls with copper;
at least one inorganic acid from 2% to 20%, preferably from 5% to 15% and/or at least one organic acid from 10% to 20%, preferably from 3% to 15% with an overall pH between 2.0 and 8.4, preferably between 4.0 and 7.0 in the case of a commercial concentrated liquid blend as defined below.

Chitosan (CAS n. 9012-76-4) is a substance that derives from chitin, a component present both in the animal kingdom, in particular in the exoskeleton of crustaceans and in the external covering of insects, and in the vegetable kingdom, in particular in mushrooms of the Aspergillus type Niger and Agaricus bisporus.

Chitosan is a polysaccharide polymer, i.e. a linear polymer of D-glucosamine, whose monomers are joined by β-(1-4) glycosidic bonds. It usually comes in the form of an odorless and tasteless whitish powder and is obtained by deacetylation of chitin, which is a polymer of N-acetyl-glucosamine; therefore, if the deacetylation is not complete, chitosan may also contain non-deacetylated amino groups.

In addition to having a direct function against pathogens, chitosans possess an original “film-forming” property, which determines the important ability to “adhesive” the additional active ingredients used in combination. Furthermore, chitosans induce plants to intensify the synthesis of proteins involved in the plant's defense systems, as well as favoring a greater accumulation of phytoalexins, i.e. those non-specific antibiotics which, compared to synthetic antifungals, are less effective but have the advantage of being accumulated directly where it is needed.

The chitosans used according to the present invention have, typically, the following chemical and physicochemical characteristics:
molecular weight equal to or less than 300 KD;
degree of deacetylation at least 70%;
viscosity from 0.02 to 0.50 Pa·s (Pascal per second), determined using a rotational viscometer ranging from 20 to 6,000,000 mln/cp;
number of monomer units typically equal to or less than 10,000 and preferably equal to about 2,000.

The chitosans used in the mixture according to the present invention can be, as has been said, both of animal and fungal derivation, they can be treated or untreated to inhibit any microbiological pollution, and can also be treated or not treated chemically or physically to achieve other purposes of efficiency of the molecule.

Cationic surfactant has a molecule characterized by a hydrophobic moiety, which carries a positive charge when the component is dissolved in water. In the most frequent case this charge is assimilated to a quaternary nitrogen atom.

The cationic surfactant, which has a high wetting capacity, assumed a certain importance when its bacteriostatic properties were discovered in 1935, thanks to which it has found its widespread use.

The main function of the cationic surfactant, which is the effective active principle, is to compromise the functionality of the cell membrane of fungi, molds and bacteria, blocking the harmful action that these could carry out against the affected vegetable, and its presence in the mixed with chitosan, it makes the latter carry out the important synergistic function of fixing the cationic surfactant to the plants and therefore enhancing its activity.

Among the cationic surfactants, the “Ethyl-N-lauroyl-L-arginate HCL” or more briefly LAE (CAS n. 60372-77-2) has been found particularly advantageous.

As stated, the copper-containing compound which has been found particularly advantageous is copper sulphate even if other types can be usefully used alone or mixed with others, subject to verification of effective miscibility with the mixture of chitosan and surfactant.

The invention has also shown that the miscibility of copper and chitosan together, a problem hitherto unsolved from the point of view of practical and economic use, is facilitated by the presence of the cationic surfactant.

The organic acid can typically be mono-or dicarboxylic and is preferably selected from acetic, lactic, malic, tartaric, fumaric, glutamic acids.

Mixtures of two or more of said acids can also be used.

Among the acids, acetic acid is particularly suitable, which itself has a marked efficacy in counteracting the proliferation of microorganisms and is advantageously used in the form of vinegar, preferably wine vinegar. As is known, vinegar is a product obtained exclusively from the acetic fermentation of alcoholic or sugary liquids of agricultural origin, which, when released for consumption, has a total acidity expressed in acetic acid of between 5 g and 12 g per 100 ml and a quantity of ethyl alcohol not exceeding 0.5% by volume. The inorganic acid which can be advantageously used is hydrochloric acid.

Regardless of the nature of the acid used, the mixture formed by the components described above, once dissolved in water at the concentrations reported above, according to a concentrated commercial formulation, has a pH between 2.0 and 8.4, preferably between 4.0 and 6.8.

In the case of a mixture in aqueous solution, its advantageous concentrated composition (commercial mixture) can be as follows, in which the individual components are expressed as a percentage by weight with respect to the total weight of the liquid mixture:
chitosan from 0.01% to 10%, preferably from 1% to 3%,
inorganic acid from 0.0005% to 1% preferably from 0.2 to 0.8% and/or organic acid from 0.00005% to 3% preferably from 0.05 to 1%,
0.05% to 5% cationic surfactant, preferably 0.10 to 1%,
compound containing copper from 0.1% to 30%,
water from 70% to 99.94%, preferably from 80 to 98.65%.

The water can be for civil or agricultural or zootechnical use or a mixture thereof. It can also have characteristics of technical purity, typically obtainable by distillation, osmosis, filtration, etc.

In the mixture according to the invention the chitosans can generally be in neutral form, ie without charge, or in salified form.

The mixture according to the invention can furthermore comprise at least one substance directly active against pathogenic microorganisms potentially harmful to the wholesomeness and health of plants and against pathogenic microorganisms potentially harmful to products intended for human and zootechnical nutrition. Furthermore, the mixture can comprise at least one substance having an eliciting activity, also of natural origin, such as for example an alga or an algal compound or an exudate thereof, in particular laminarin.

The mixture concentrated in aqueous solution, i.e. the mixture, which has the commercial concentration, can be used as such or it can be further diluted by the user until it reaches concentration values ranging from 0.5% of the commercial mixture itself up to even 100%, depending on the degree of infection, the type of parasite, the type of plant to be treated or the food composition intended for humans and/or animals. Also in this case the water can be water for civil or agricultural or zootechnical use or a mixture thereof. It can also have characteristics of technical purity, typically obtainable by distillation, osmosis, filtration, etc.

Once diluted with water, the commercial liquid mix forms a new liquid mix having the correct dilution for the required use. This new mixture preferably has a pH value between 6.5 and 8.0 and is ready to be used. It can be sprayed on the field, preferably with special distribution systems, on the green parts of the plants, on the woods and/or on the fruits before or after their harvest. In the case of vines, the aqueous mixture can be sprayed on the plants and on the bunches of grapes still attached to the plants or detached from them. In other words, the aqueous mixture is brought into contact with the interested parts of the plants so as to be able to exert a directly inhibiting effect with respect to the pathogens considered as well as a further eliciting effect, through which the plant is stimulated to produce its own metabolites useful for the defense against these pathogens.

By then choosing the composition of the mixture in an appropriate manner, its use can also be envisaged on food products while maintaining the edibility characteristics.

To prepare the mixture according to the invention in its commercial aqueous version it is preferable that the chitosan is in the form of an organic or inorganic salt, preferably as a halide or even better as a chloride. Even if the temporal order of introduction of the components is not binding, it is preferable to first add the chitosan to the water and, keeping stirring, introduce the organic and/or inorganic acids, the cationic surfactant and lastly, always keeping alive the stirring, the molecules containing the copper. At the end of the preparation the mixture can have a significant viscosity.

The mixture according to the present invention can be a homogeneous or heterogeneous mixture; in fact, it can comprise a polymeric fraction of undeacetylated D-glucosamine, i.e. chitin. This fraction is not soluble in water, not even in the acidic conditions that arise at the time of use and therefore remains in suspension. Generally, this insoluble fraction constitutes less than 30%, typically less than 10% and preferably from 2% to 5% with respect to the weight of the chitosans present in the mixture.

The mixture according to the invention can be used to prepare a commercial concentrated aqueous mixture to be diluted in water at the moment of use or an already diluted aqueous mixture, ready for its immediate use.

The mixture according to the invention can also be used in the powder state, ie by mixing the components which form it with a solid vehicle, for example talc, perlite, kaolin, zeolite, bentonite, etc. In this case the constituent components of the commercial mixture in powder form must all have a powdery nature. In particular, since chitosan, the cationic surfactant and the inorganic molecules containing copper are naturally in solid form (powder), organic and/or inorganic acids must also be used which are also of a solid nature (powder).

The mixture according to the invention can be used on plants by direct sprinkling with manual mode or thanks to specially arranged sprayers. In this case the mixture according to the invention will preferably be mixed, depending on the agricultural equipment available, in a suitable solid vehicle, for example talc in a ratio preferably between 1/5 and 1/20, so as to form a balanced dispersion of the mixture.

A typical mixture recipe for obtaining a commercial mixture in powder form to be used directly in powder form and to be dispersed in one hectare of land can advantageously be the following:
chitosan 100g to 1000g, preferably 300g to 600g,
organic acid with 2-6 carbon atoms of 10 g to 100 g, preferably of 20 g to 60 g and inorganic acid or mixture of inorganic acids, also salified in whole or in part, of 10 g to 100 g, preferably of 20 g to 60 g,
organic or inorganic molecule or mixture of these containing 0.5 g of copper. to 400 g, preferably from 200 to 400 g, in case the mixture is used in the agronomic field, or preferably from 0.05 g to 10 g, in case the mixture is used in food preparations for human or zootechnical use;
5 g to 100 g cationic surfactant, preferably 10 g to 60 g.

The commercial powder mixture thus obtained can be used on plants in two different ways and more precisely by direct sprinkling of the plants with the commercial powder mixture or by dispersion of the powders of the commercial mixture in a solid vehicle (zeolite, talc, perlite, etc.) and subsequent sprinkling of the plants with this new diluted pulverulent mixture.

In the case of direct sprinkling of plants with powders, this can take place manually or with sprayers specifically set up for mechanized agricultural sprinkling. In this second case, depending on the agricultural equipment available, the mixture according to the invention can possibly be diluted in other powder(s) (e.g. zeolite, perlite, talc, etc.) in a ratio of, for example, 1/5-1/20, which favors its balanced dispersion. In the case of direct sprinkling with the powdery mixture, the effectiveness of the treatment increases particularly if the sprinkling takes place after wetting the plants. The treatment is particularly valid, for example, if the dew present in the morning on the aerial parts of the plants is exploited or if these are treated immediately at the end of an irrigation called “overhead” or after an intensely rainy or hail phenomenon and/or such as to make it impossible to proceed in the countryside with the treatment using the classic agricultural “atomizer”, too heavy to be able to advance on the ground made muddy by the meteoric event. Naturally, it is possible to proceed with a preventive wetting of the vegetable through the sprinkling of water followed by the subsequent application of the commercial powdered mixture or of the diluted powdered commercial mixture. In the case of use in the human or zootechnical food sector, the mixture can be advantageously used directly on recipes that include powdery or in any case solid ingredients, intended or not intended for further mixing with water or even on the surfaces of previously cooked products or products derived from fermentation such as cheese or other.

As has been said, the mixture according to the invention, both in its form of commercial viscous liquid or diluted commercial and in the form of diluted powder or commercial diluted, can be used directly on plants in the open field or in a protected environment, in the various phases vegetative growth of plants during their life cycle. Typically on the vine plant, and/or on the fruits before or after their harvest and/or on the transformation products of these fruits.

Alternatively, with the mixture according to the invention, both in its form of diluted commercial or commercial viscous liquid and in diluted commercial or commercial powder, fruits, for example bunches of grapes, rather than apples or cherries can be treated. or strawberries placed in crates or other containers immediately after harvesting or during any moment of storage of said products mentioned for example.

Regardless of the sprinkling methods, the mixture according to the invention helps the plant to maintain the health of the fruit and leaves and therefore of the whole plant, causing it to activate its defenses against fungal pathogens, for example the aforementioned Plasmopara viticola, Ascomycetes and Botrytis cinerea. Other microorganisms, for example lactic and acetic bacteria, which fall within the technological cycle of the transformation of fruit from plants, for example grapes, not being affected by the eliciting activities of the plant, directly undergo the inhibiting activity of chitosan and cationic surfactant in them comparisons.

Basically, the mixture according to the present invention can also be used, and not only, in the fight against the deterioration of plants and their fruits, in particular following diseases of fungal and bacterial origin. In particular, this mixture can be used in crops for the production of fruit both for the table and for any subsequent technological food transformation. In the case for example of fresh grapes, the treatments with the mixture according to the invention can be carried out in one or more phenological stages of the plant, from budding to leaf fall. In particular, for the containment of Plasmopara viticola, treatments can be carried out in the various phenological phases according to the rule of the three 10 s (i.e., first infection with a minimum temperature equal to or higher than 10° C.; precipitation of at least 10 mm in the space of 24-48 hours; shoot length at least 10 cm) and according to the Goidanich table.

The mixture according to the present invention can actually replace the traditional treatments carried out with covering products, in particular for example those with the exclusive use of metals such as copper.

The mixture according to the present invention can be, for example, effectively used for the inhibition of fungi, bacteria and viruses on cereal or soy agricultural crops or other plants with an annual or polyannual cycle intended for human or zootechnical food production. In particular, the mixture finds application in the conservation of seeds and haymaking.

Given its edible character, the mixture according to the present invention can also be effectively used in food preparations for human or zootechnical use to inhibit the proliferation of fungi, bacteria and viruses.

The aqueous mixture according to the present invention can also be prepared in liquid form to be sent to the known so-called “spray drying” technology, which leads to obtaining the dried mixture ready to be mixed in water and thus used.

It has been found that the mixture according to the invention, in addition to highlighting the important role of the surfactant in making possible the miscibility of copper with chitosan, a problem which had not found a solution in the past from the point of view of practical and economic use, has highlighted numerous advantages compared to the state of the art, and in particular:
determines a general improvement in the health conditions of plants, so as to preserve the quality and quantity of agricultural production, limiting or inhibiting the reproduction and growth of fungal, viral and bacterial populations;
improves the shelf life of agricultural products after harvesting, and in particular of fruit, plant parts, buds, leaves, flowers and seeds; storage after harvesting can in fact benefit in particular from treatment with this mixture as this, by limiting or inhibiting the reproduction and growth of viral, bacterial and above all fungal populations, limits the production of the metabolite “Ochratoxin” or “OTA”. substance defined by the EFSA (European Food Safety Authority) as “genotoxic”;
selectively contrasts the fungal and bacterial population on the parts detached from the plant so that further supply chain processes can proceed in the absence of this, with a potential lower use of synthetic bactericidal and/or antifungal substances or substances considered toxic or allergenic for humans, and among these in particular, in the case of wine grapes, sulfur dioxide;
allows it to be mixed, in its commercial or diluted commercial powder formulation, with other pesticides such as copper, without miscibility problems,
maintains healthy conditions, in the case of the plant grafting technique, where internal woody parts of these are exposed to atmospheric or technological elements due to the necessary cuts required to implement the fusion of different plants. In particular, the mixture according to the invention is conveniently used to coat the grafting area, dosed or not dosed, with any “callus” promoting hormones. The grafting area can subsequently be covered with suitable waxes or paraffins and the vegetable, or part of it, can be forced into special forcing rooms. The same method can be adopted for grafts on plants in the open field;
guarantees the health conditions of plants or parts of them affected by meteorological adversities such as hail or other atmospheric phenomena or by insect attacks, which can cause mechanical wounds on plants or parts of them, especially fruit;
improves the resistance of plants to water stress, following the closure of the stomata and the decreased overall transpiration of the plant; moreover, it counteracts the loss of water in the fruit, for example in grapes, thanks to the ability of the mixture to form a filming film around it, hindering the evaporation of the water present inside it;
preserves house plants, aromatic or cut flowers, from contamination by synthetic chemicals and therefore makes them usable in domestic environments (closed).

All these advantages can be obtained in the treatment of many plant species, given that no plant is immune to the pathological action of fungi, bacteria and viruses.

From a general and non-limiting point of view, the mixture according to the invention can be profitably used for plants belonging to the following orders:

Rosaceae, in particular apple, peach, pear, strawberry, blackberry, raspberry and others;
Cucurbitaceae, in particular cucumber, courgette, melon, watermelon and others;
Solanaceae, in particular tomatoes, aubergines, potatoes, peppers, tobacco and others;
Punicaceae, in particular the pomegranate and others;
Amaryllidaceae, especially the onion and others;
Fabaceae, in particular the lentil, broad bean and others;
Asteraceae, in particular lettuce, escarole and others;
Apiaceae, in particular the carrot and others;
Actinidiaceae, in particular the kiwi and others.

1.-20 (canceled)

21. Mixture for the antifungal, antibacterial and antiviral treatment of plants in general and of ingredients or foods intended for human and/or zootechnical consumption comprising, in a powder form, the following weight composition:
at least one chitosan or at least one salified chitosan: 100 g to 1000 g,
ethyl-N-lauroyl-L-arginate hydrochloride HCL (LAE): 5 g to 100 g,
at least one copper salt from the group consisting of: copper sulphate, copper oxychloride, copper gluconate and copper citrate: 0.05 g to 400 g,
organic acid with 2-6 carbon atoms: 10 g to 100 g, and inorganic acid or mixture of inorganic acids, also salified in whole or in part: 10 g to 100 g, and comprising in an aqueous form the following weight composition:
at least one chitosan or at least one chitosan salified with hydrated inorganic acid: 0.01% to 10%,
ethyl-N-lauroyl-L-arginate hydrochloride HCL (LAE): 0.05% to 5%,
at least one copper salt from the group consisting of: copper sulphate, copper oxychloride, copper gluconate and copper citrate: 0.1% to 30%,
at least one organic acid: 0.00005% to 3%, and/or at least one inorganic acid: 0.0005% to 1%,
water: 51% to 99.84%,
said at least one chitosan being selected from the group having the following chemical and physicochemical characteristics:
molecular weight: equal to or less than 300 KD;
degree of deacetylation: at least 70%;
viscosity: 0.02 to 0.50 Pa·s, determined using a rotational viscometer ranging from 20 to 6,000,000 mln/cp; and
number of monomer units: 2,000 to 10,000.

22. The mixture according to claim 21 comprising at least one chitosan in the form of an organic or inorganic salt.

23. The mixture according to claim 22 wherein the mixture comprises at least one chitosan in the form of a halide.

24. The mixture according to claim 21, wherein the at least one powder or aqueous copper salt is copper sulphate.

25. The mixture according to claim 21, wherein the at least one powder or aqueous copper salt is copper oxychloride.

26. The mixture according to claim 21, wherein the at least one powder or aqueous copper salt is copper gluconate.

27. The mixture according to claim 21 further comprising copper citrate.

28. The mixture according to claim 21, wherein the mixture comprises a mono- or dicarboxylic organic acid.

29. The mixture according to claim 21, wherein the mixture comprises an organic acid selected from the group consisting of: acetic acid, lactic acid, malic acid, tartaric acid and glutamic acid.

30. The mixture according to claim 21, wherein the mixture comprises hydrochloric acid.

31. The mixture according to claim 21, wherein the mixture comprises at least one substance having an elicitory activity.

32. Powder mixture wherein the powder mixture comprises a powder mixture according to claim 21 diluted in a suitable inert powder support, selected from the group consisting of: talc, perlite, kaolin, bentonite and zeolite, in percentage by weight between 10% and 20%.

33. The mixture according to claim 21, wherein in the powder form the weight composition of:
said at least one chitosan or said at least one salified chitosan is 300 g to 600 g,
said ethyl-N-lauroyl-L-arginate hydrochloride HCL (LAE) is 10 g to 60 g,
said at least one copper salt is 200g to 400g, if the mixture is used in the agronomic field,
said organic acid with 2-6 carbon atoms is 20 g to 60 g, and said inorganic acid or mixture of inorganic acids, also salified in whole or in part is 20g to 60g, and wherein in said aqueous form the amount of:
said inorganic acid is 1% to 3%,
said ethyl-N-lauroyl-L-arginate hydrochloride HCL (LAE) is 0.1% to 1%,
said at least one organic acid is 0.05% to 1%, and/or said at least one inorganic acid is 0.2% to 0.8%, and
said water is 64.2% to 98.75%.

34. The mixture according to claim 21, wherein in the powder form the weight composition of:
said at least one chitosan or said at least one salified chitosan is 300 g to 600 g,
said ethyl-N-lauroyl-L-arginate hydrochloride HCL (LAE) is 10 g to 60 g,
said at least one copper salt is 0.05 g to 10 g, if the mixture is used in food preparations for human or zootechnical use,
said organic acid with 2-6 carbon atoms is 20 g to 60 g, and said inorganic acid or mixture of inorganic acids, also salified in whole or in part is 20 g to 60 g, and wherein in said aqueous form the amount of:
said inorganic acid is 1% to 3%,
said ethyl-N-lauroyl-L-arginate hydrochloride HCL (LAE) is 0.1% to 1%,
said at least one organic acid is 0.05% to 1%, and/or said at least one inorganic acid is 0.2% to 0.8%, and
said water is 64.2% to 98.75%.

35. The mixture according to claim 22 wherein the mixture comprises at least one chitosan in the form of a chloride.

36. The mixture according to claim 21, wherein the mixture comprises at least one alga, an exudate of an alga or laminarin.

37. Mixture for the antifungal, antibacterial and antiviral treatment of plants comprising, in a powder form, the following weight composition:
at least one chitosan or at least one salified chitosan: 300 g to 600 g,
ethyl-N-lauroyl-L-arginate hydrochloride HCL (LAE): 10 g to 60 g,
at least one copper salt from the group consisting of: copper sulphate, copper oxychloride, copper gluconate and copper citrate: 200 g to 400 g,
organic acid with 2-6 carbon atoms: 20 g to 60 g, and inorganic acid or mixture of inorganic acids, also salified in whole or in part: 20 g to 60 g,
and comprising in an aqueous form the following weight composition:
at least one chitosan or at least one chitosan salified with hydrated inorganic acid: 1% to 3%,
ethyl-N-lauroyl-L-arginate hydrochloride HCL (LAE): 0.1% to 1%,
at least one copper salt from the group consisting of: copper sulphate, copper oxychloride, copper gluconate and copper citrate: 0.1% to 30%,
at least one organic acid: 0.05% to 1%, and/or at least one inorganic acid: 0.2% to 0.8%,
water: 64.2% to 98.75%,
said at least one chitosan being selected from the group having the following chemical and physicochemical characteristics:
molecular weight: equal to or less than 300 KD;
degree of deacetylation: at least 70%;
viscosity: 0.02 to 0.50 Pa·s, determined using a rotational viscometer ranging from 20 to 6,000,000 mln/cp; and
number of monomer units: 2,000 to 10,000.

38. Mixture for the antifungal, antibacterial and antiviral treatment of foods intended for human and/or zootechnical consumption comprising, in a powder form, the following weight composition:
at least one chitosan or at least one salified chitosan: 300 g to 600 g,
ethyl-N-lauroyl-L-arginate hydrochloride HCL (LAE): 10 g to 60 g,
at least one copper salt from the group consisting of: copper sulphate, copper oxychloride, copper gluconate and copper citrate: 0.05 g to 10 g,
organic acid with 2-6 carbon atoms: 20 g to 60 g, and inorganic acid or mixture of inorganic acids, also salified in whole or in part: 20 g to 60 g,
and comprising in an aqueous form the following weight composition:
at least one chitosan or at least one chitosan salified with hydrated inorganic acid: 1% to 3%,
ethyl-N-lauroyl-L-arginate hydrochloride HCL (LAE): 0.1% to 1%,
at least one copper salt from the group consisting of: copper sulphate, copper oxychloride, copper gluconate and copper citrate: 0.1% to 30%,
at least one organic acid: 0.05% to 1%, and/or at least one inorganic acid: 0.2% to 0.8%,
water: 64.2% to 98.75%,
said at least one chitosan being selected from the group having the following chemical and physicochemical characteristics:
molecular weight: equal to or less than 300 KD;
degree of deacetylation: at least 70%;
viscosity: 0.02 to 0.50 Pa·s, determined using a rotational viscometer ranging from 20 to 6,000,000 mln/cp; and
number of monomer units: 2,000 to 10,000.
